(19) United States
(12) Patent Application Publication
(10) Pub. No.: US 2011/0109466 A1
(43) Pub. Date: May 12, 2011

(54) POWER SUPPLY SYSTEM

(75) Inventor: MING-CHIH HSIEH, Tu-Cheng (TW)

(73) Assignee: HON HAI PRECISION INDUSTRY CO., LTD., Tu-Cheng (TW)

(21) Appl. No.: 12/628,179

(22) Filed: Nov. 30, 2009

(30) Foreign Application Priority Data
Nov. 10, 2009 (CN) 200910309515.9

(51) Int. Cl. G08B 21/00

(52) U.S. Cl. 340/636.1

(57) ABSTRACT

A power supply system can conveniently supply power to a network transmission device and a sensor. When a host sends instructions to obtain environmental readings as pulse signals to a radio frequency (RF) antenna, the RF antenna absorbs electrical energy from the pulse signals to charge an ultra-capacitor. The ultra-capacitor supplies power to the network transmission device and the sensor.

### BACKGROUND

1. Technical Field

The present disclosure relates to a power supply system.

2. Description of Related Art

Nowadays, wireless network environment monitoring devices, such as ZigBee® terminal devices, are widely used. The ZigBee® terminal devices adopt ZigBee® technology to monitor temperature, humidity etc. When a host sends an instruction to obtain environmental readings to a ZigBee® terminal device, the ZigBee® terminal device can send the readings to the host to be processed via a wireless network. However, power for the ZigBee® terminal device is generally supplied by a rechargeable or non-rechargeable battery, therefore, the battery must be replaced or recharged frequently, and eventually the battery will be discarded, thus polluting the environment.

### BRIEF DESCRIPTION OF THE DRAWINGS

FIG. 1 is a block diagram of a first exemplary embodiment of a power supply system.

FIG. 2 is a block diagram of a second exemplary embodiment of a power supply system.

### DETAILED DESCRIPTION

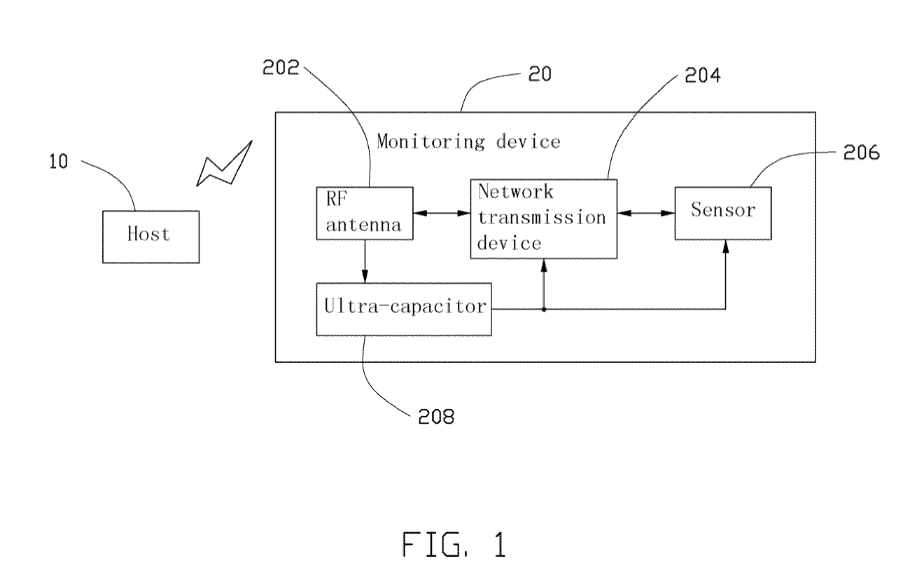

Referring to FIG. 1, a first exemplary embodiment of a power supply system includes a host 10, a monitoring device 20 for monitoring environmental conditions, such as temperature, humidity etc. The monitoring device 20 includes a radio frequency (RF) antenna 202, a network transmission device 204, a sensor 206, and an ultra-capacitor 208. The RF antenna 202 is connected to the ultra-capacitor 208 and the network transmission device 204. The ultra-capacitor 208 is also connected to the network transmission device 204 and the sensor 206. The network transmission device 204 is also connected to the sensor 206. The monitoring device 20 is a ZigBee® wireless network monitoring device, the network transmission device 204 is a hub, and the ultra-capacitor 208 can be quickly charged.

In use, the host 10 sends instructions to obtain environmental readings as pulse signals to the RF antenna 202. The RF antenna 202 receives the pulse signals and absorbs electrical energy from the pulse signals to charge the ultra-capacitor 208, and sends data signals of the pulse signals to the sensor 206 via the network transmission device 204. The ultra-capacitor 208 supplies power to the network transmission device 204 and the sensor 206. After receiving the data signals, the sensor 206 reads and sends detected environmental conditions, such as temperature and humidity, to the host 10 to be processed via the network transmission device 204 and the RF antenna 202.

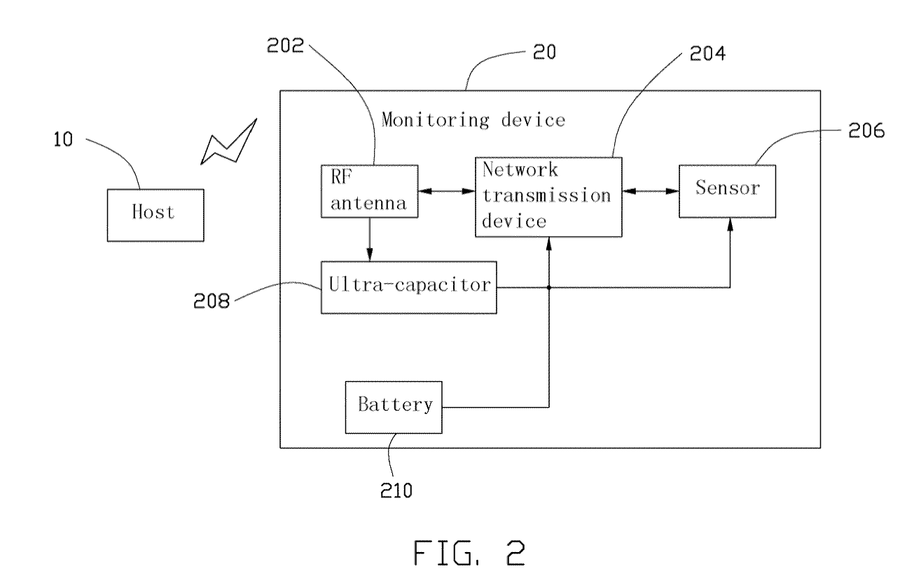

Referring to FIG. 2, a difference between a second exemplary embodiment of a power supply system and the first exemplary embodiment of the power supply system is as follows. The monitoring device 20 further includes a battery 210. The battery 210 is connected to the network transmission device 204, the sensor 206, and the ultra-capacitor 208, to supply power to the network transmission device 204 and the sensor 206. Working principle of the second exemplary embodiment of the power supply system is substantially the same as the second exemplary embodiment of the power supply system. The ultra-capacitor 208 also charges the battery 210. The ultra-capacitor 208 and the battery 210 supply power to the network transmission device 204 and the sensor 206, therefore service life of the battery 210 and the ultra-capacitor 208 is increased. The battery 210 is charged by the ultra-capacitor 208, thereby saving electricity.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A power supply system comprising:
a host to send instructions to obtain environmental readings as pulse signals; and
a monitoring device to monitor an environmental condition, and comprising:
a radio frequency (RF) antenna to receive the pulse signals and absorb electrical energy from the pulse signals, and send data signals of the pulse signals;
a network transmission device connected to the RF antenna;
a sensor to read and send an environmental condition, the sensor being connected to the network transmission device to send the detected environmental condition to the host via the network transmission device and the RF antenna after the sensor receives the data signals; and
an ultra-capacitor connected to the RF antenna, the network transmission device, and the sensor, to use the electrical energy to supply power to the network transmission device and the sensor.

2. The system of claim 1, wherein the environmental condition is an environmental temperature.

3. The system of claim 1, wherein the environmental condition is environmental humidity.

4. The system of claim 1, wherein the network transmission device is a hub.

5. The system of claim 1, further comprising a battery to supply power to the network transmission device and the sensor.

6. The system of claim 5, wherein the ultra-capacitor further charges the battery.
